(19) United States
(12) Patent Application Publication
(10) Pub. No.: US 2018/0020040 A1
(43) Pub. Date: Jan. 18, 2018

(54) METHOD AND DEVICE FOR HTTP STREAMING OVER UNRELIABLE TRANSPORT PROTOCOL

(71) Applicant: CANON KABUSHIKI KAISHA, Tokyo (JP)

(72) Inventors: HERVÉ RUELLAN, RENNES (FR); FRANCK DENOUAL, SAINT DOMINEUC (FR); FRÉDÉRIC MAZE, LANGAN (FR)

(21) Appl. No.: 15/644,521

(22) Filed: Jul. 7, 2017

(30) Foreign Application Priority Data
Jul. 13, 2016 (GB) 1612198.0

(51) Int. Cl. H04L 29/08; H04L 1/18; H04L 1/16; H04L 29/06

(52) U.S. Cl. CPC H04L 67/02; H04L 69/165; H04L 1/1809; H04L 1/1614; H04L 1/1664; H04L 67/42

(57) ABSTRACT

The present invention relates according to a first aspect to method and device for transmitting data packets from a first device to a second device, the method comprising at the first device:
sending a data packet to the second device;
if a request for retransmitting the data packet is received from the second device, the method further comprising:
obtaining reliability information on whether the sent data packet is of reliable type or unreliable type; and
if the data packet is of reliable type, then the data packet is resent to the second device; and
if the data packet is of unreliable type, then a notification is sent to the second device for notifying the second device that the data packet is not to be resent.

### CROSS REFERENCE TO RELATED APPLICATION

This application claims the benefit under 35 U.S.C. §119(a)-(d) of United Kingdom Patent Application No. 1612198.0, filed on Jul. 13, 2016, and entitled “Method and device for http streaming over unreliable transport protocol”. The above cited patent application is incorporated herein by reference in its entirety.

### FIELD OF THE INVENTION

The present invention relates in general to transmission of data between a server device and a client device in a communication network, and in particular to method and device for unreliable HTTP streaming.

### BACKGROUND OF THE INVENTION

HTTP (HyperText Transfer Protocol) is an application protocol used on top of TCP/IP (Transmission Control Protocol/Internet Protocol) allowing data exchanges over the Internet. More specifically, the HTTP protocol allows a client and a server to communicate by exchanging requests and responses.

Usually, the client sends an HTTP request to the server, thereby asking for a specific resource, and the server replies by sending the resource back to the client. HTTP requests and responses (also referred to as HTTP messages) are transmitted on a TCP connection between the client and the server. An HTTP message is made of two parts: a header part containing one or more header fields, each header field containing metadata about the message and its transport, and a body part containing application data.

The use of TCP as underlying protocol ensures reliability but introduces delays due to the retransmission of corrupted or lost data.

Consequently, there is a need for improving the management of delays, in particular when the HTTP protocol is used for streaming video data.

### SUMMARY OF THE INVENTION

The present invention has been devised to address one or more of the foregoing concerns.

In this context, there is provided a solution based on an unreliable protocol such as UDP for the transport of HTTP messages while maintaining sufficient reliability and reducing transmission latencies.

According to a first aspect of the invention, there is provided a method for transmitting data packets from a first device to a second device, the method comprising at the first device:

sending a data packet to the second device;

if a request for retransmitting the data packet is received from the second device, the method further comprising:

obtaining reliability information on whether the sent data packet is of reliable type or unreliable type; and

if the data packet is of reliable type, then the data packet is resent to the second device; and

if the data packet is of unreliable type, then a notification is sent to the second device for notifying the second device that the data packet is not to be resent.

According to a second aspect of the invention, there is provided a method for transmitting data packets from a first device to a second device, the method comprising at the first device:

for each data packet to be transmitted, obtaining reliability information on whether the data packet is of reliable type or unreliable type;

constructing an association table associating identifiers of a plurality of data packets and corresponding reliability information; and

sending a data packet to the second device, wherein the sent data packet include the association table constructed for data packets previously transmitted.

According to a third aspect of the invention, there is provided a method for receiving by a second device data packets from a first device, the method comprising at the second device:

receiving a data packet from the first device;

retrieving from the received data packet an association table associating identifiers of a plurality of data packets, previously transmitted by the first device, and corresponding reliability information;

determining, based on the association table, a data packet previously transmitted by first device, not correctly received by second device, a which is of reliable type; and

requesting retransmission of the data packet.

All the aspects of the present invention have optional features and advantages similar to the first aspect above-mentioned.

Since the present invention may be implemented in software, the present invention may be embodied as computer readable code for provision to a programmable apparatus on any suitable carrier medium, and in particular a suitable tangible carrier medium or suitable transient carrier medium. A tangible carrier medium may comprise a storage medium such as a floppy disk, a CD-ROM, a hard disk drive, a magnetic tape device or a solid state memory device or the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 describes the general architecture of the system in which embodiments of the invention may be implemented;

FIG. 2 describes the protocol stack according to embodiments of the invention;

FIGS. 3a and 3b describes the signalling on the sender side, FIG. 3a illustrates the flowchart and FIG. 3b gives a representation of the inter-layer signalling based on the architecture of FIG. 2;

FIGS. 4a, 4b, 5a and 5b describe two possibilities for the signalling between the sender and the receiver;

FIG. 4a illustrates the flowchart and FIG. 4b gives a representation of the inter-layer signalling based on the architecture of FIG. 2;

FIG. 5a illustrates the flowchart and FIG. 5b gives a representation of the inter-layer signalling based on the architecture of FIG. 2;

FIG. 6 describes the mechanism used on the receiver side to inform the different layers that a HTTP message is transferred in an unreliable way;

FIG. 7 describes another mechanism used on the receiver side to inform the different layers that a HTTP message is transferred in an unreliable way;

FIG. 8 describes an algorithm used by the sender to inform the receiver that a missing TA packet was sent unreliably;

FIG. 9 describes the preferred mechanism for informing the receiver that a TA packet is sent unreliably;

FIG. 10 describes the processing on the receiver side;

FIG. 11 describes the processing according to this new mechanism on the sender side;

FIG. 12 describes the processing on the receiver side;

FIG. 13 describes a first mechanism based on gap detection during the reconstruction of the TA stream;

FIG. 14 describes a second mechanism based on a timeout system;

FIG. 15 described a third mechanism based on the detection of a packet loss;

FIG. 16 describes how the lost data size is evaluated; and

FIG. 17 represents a block diagram of a device, in which steps of one or more embodiments may be implemented.

### DETAILED DESCRIPTION OF EMBODIMENTS OF THE INVENTION

Architecture

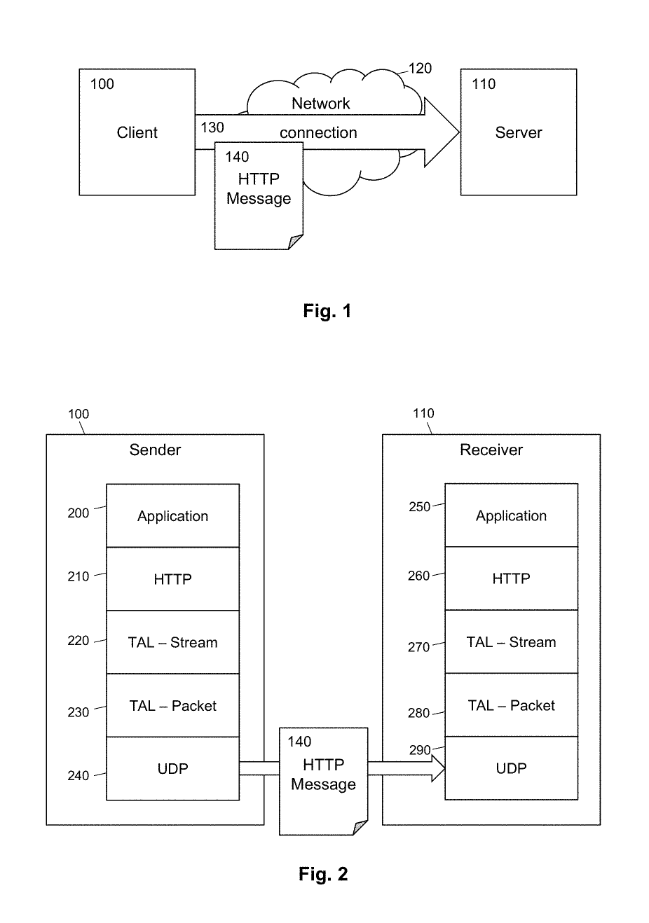

FIG. 1 describes the general architecture of the system, where a client (100) sends an HTTP message (140) to a server (110), through a connection (130) established over a network (120).

In HTTP a client sends a HTTP request to a server and the server replies with a HTTP response. Both HTTP request and HTTP response are HTTP messages. A client may thus by a sender and a receiver of HTTP messages. Similarly, a server may be a sender and a receiver of HTTP messages.

Hereinafter, no distinction is made between HTTP requests and HTTP responses. However, it is expected that in general HTTP requests will be sent reliably while some HTTP responses may be sent unreliably. Indeed, a common use-case for the unreliable transmission of HTTP messages is the server sending back to the client a media stream in an unreliable way. However, in some cases, the HTTP client could send a HTTP request in an unreliable way, for example for sending a media stream to the server.

FIG. 2 describes the protocol stack according to embodiments of the invention. The protocol stack exists on both client and server sides. On the client side, the protocol stack takes a message from the application to send it through the network. On the server side, the message is received from the network and transmitted to the application through the protocol stack.

On the client side, the protocol stack contains at the top level the application (200). This can be for example a web application, e.g. a client part running in a web browser. Underneath is the HTTP layer (210), which implements the HTTP protocol semantics, providing an API for the application to send and receive messages. Underneath is a transport adaptation layer (TA layer or TAL) divided into two sublayers: a stream sublayer 220 (TA Stream sublayer or TAS sublayer) and a packet sublayer 230 (TA Packet sublayer or TAP sublayer). These sublayers enable to transport HTTP messages on top of UDP (240).

On the server side, the protocol stack contains the same layers. The top level application (250) may be for example the server part running in a web server. The HTTP layer (260), the TAS sublayer (270), the TAP sublayer (280) and the UDP layer (290) are the counterparts of the layers 200, 210, 220, 230 and 240 respectively.

From a physical point of view, an information exchanged between the client and the server starts at a given level on the sender side, is transmitted through all the lower layers down to the network, is physically sent through the network to the receiver, and is transmitted through all the lower layers on the receiver side up to the same level as the initial level on the sender side. For example, an information starting at the HTTP layer is encapsulated in the HTTP message. This HTTP message is transmitted to the TA Stream sublayer, which transmits it to the TA Packet sublayer, and so on down to the physical network. On the receiver side, the HTTP message is received on the physical network and transmitted to the TA Packet sublayer, through the TA Stream sublayer, up to the HTTP layer, which decode it to retrieve the information.

From a logical point of view, at any level a message is generated, transmitted through the network and received by the receiver at the same level. From this viewpoint, all the lower layers are an abstraction that enables to transmit a message from the sender to the receiver. This logical point of view is adopted in the rest of the description.

HTTP is an application protocol used traditionally on top of TCP/IP allowing data exchanges over the Internet.

HTTP/2 (RFC 7540) is a new version of the HTTP protocol. HTTP/2 keeps the existing HTTP semantics while changing the wire syntax. This enables HTTP/2 to multiplex many HTTP request-response exchanges over a single connection. Each HTTP message is transported inside an HTTP/2 stream. A stream, in turn, is made of one or several frames.

HTTP/2 encodes HTTP header fields using HPACK (RFC 7541). For encoding and decoding HTTP header fields, HPACK uses an encoding table which evolves in a symmetric way at the encoder and the decoder. The encoder can encode a header field either as a literal or as an index. When encoding a header field as a literal, the encoder can add it to the table to later reuse it. Upon receiving the header field, the decoder will also add it to the table. The encoder can also select not to add it to the table, which the decoder will also do. Last, the encoder can encode a header field already present in the table by using its index. The decoder will receive the index and retrieve the header field from the table.

In this way, HPACK enables to encode header fields in a more compact way. However, header fields, and in particular sets of header fields corresponding to different HTTP messages, must be decoded in their encoding order to ensure the encoding and decoding tables match each other.

Transport Adaptation layer (TAL) is a transport protocol built on top of UDP and targeted at transporting HTTP messages according to embodiments of the invention.

At the higher level, TAS sublayer provides streams that are bi-directional logical channels. When transporting HTTP messages, a stream is used to transport a request from the client to the server and the corresponding response from the server back to the client. As such, a TA stream is used for each request/response pair. In addition, one TA stream associated with a request/response exchange is dedicated for carrying the request body and the response body. All the header fields of HTTP requests and responses are carried by a specific TA stream. In addition these header fields are encoded using HPACK as for HTTP/2.

To transfer data belonging to a TA stream, data is split up into TA frames. One or more TA frames are encapsulated into a TA packet which is itself encapsulated into a UDP packet to be transferred between the client and the server. There are several types of TA frames, the STREAM frames carry data corresponding to TA streams, the ACK frames carry control information about received TA packets, and other frames are used for controlling the TA connection. There are also several types of TA packets, one of those being used to carry TA frames.

In the rest of this document, the terms TA packet and TA frame will be used interchangeably as representing data belonging to a TA stream and transported inside a UDP packet. Where necessary, the distinction will be made explicit.

The User Datagram Protocol (UDP) is a simple protocol for sending data from one computer to another. It doesn't provide any connection nor any guarantee of delivery, ordering or duplicate protection. A message transported by UDP is a datagram which is carried inside an IP packet.

The Internet Protocol (IP) which has two main versions, IPv4 and the new IPv6 is one of the core protocols used by the Internet. It enables transporting packets between two computers through a network, possibly across several links.

The Transmission Control Protocol (TCP) provides a reliable connection between two computers on top of IP. Data transported through a TCP connection is split into TCP segment, each TCP segment being carried inside an IP packet.

Reliable/Unreliable Parts

Embodiments of the invention advantageously makes it possible to transport, from a sender to a receiver, in an unreliable way some HTTP messages, while other HTTP messages are still transported in a reliable way. Here, transporting a HTTP message unreliably implies that possibly a part of it could be missing. However, the ordering of the different parts of the HTTP message will still be preserved, and no part will be duplicated.

By providing the possibility for the TA layer to transport a HTTP message in an unreliable way, a decision is to be made on what part, if not all, of the HTTP it is acceptable to be transported unreliably.

A first solution is to transport the header fields reliably and to transport the body unreliably. Due to the usage of HPACK, if some header fields encoded by the sender are not received by the receiver, then the HPACK encoding and decoding tables may become incoherent, preventing the decoding of any further transmitted header fields. For this reason, it is simpler to ensure that the header fields are transmitted reliably.

As an option, the header fields could also be transported unreliably. In this case, the encoding of the headers shouldn't modify the encoding and decoding tables. In addition, some specific steps must be taken in signalling to the receiver that the HTTP message is transported in an unreliable way (discussed below).

As another option, part of the message body could be transported reliably. For example, in the case of a video segment, it can be interesting to ensure that the beginning of the video, usually containing some information about the video, its characteristics and its encoding, is correctly received by the decoder. For such cases, the beginning of the message body could be transported reliably, while the rest of the message body would be transported unreliably.

As another option, several parts of the message body could be transported reliably. This could be useful, for example, to transport reliably the most important parts of a video segment (i.e. not only the initial setup of the video, but also some more important data such as intra-frames).

### First Embodiments—Signalling

The first problem to solve for enabling the unreliable transmission of HTTP messages is to be able to signal that a message is sent in an unreliable way.

Indeed, there is a need for the sender to inform the receiver that a HTTP message is transferred unreliably. Second, at both the sender and receiver sides, all the layers processing the HTTP message need to be informed that the message is transferred unreliably.

Sender Side-Signalling

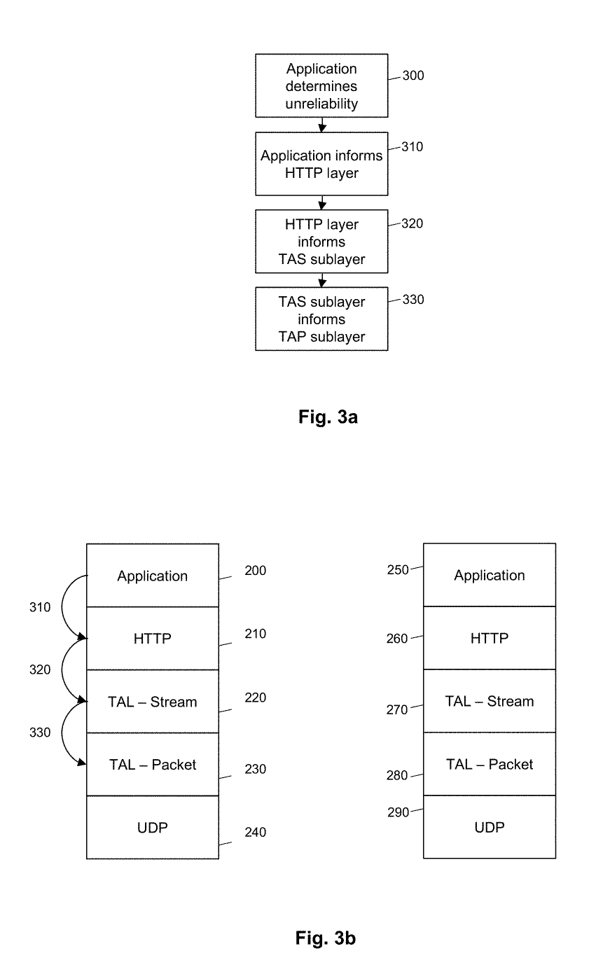

FIGS. 3a and 3b describes the signalling on the sender side (either at a client or at a server). FIG. 3a illustrates the flowchart and FIG. 3b gives a representation of the inter-layer signalling based on the architecture of FIG. 2.

First (300), the application determines that a HTTP message will be transferred unreliably. It may rely on different mechanisms for doing this. For example a server may be configured to return a set of HTTP responses in an unreliable way. It may also be configured to return a type of HTTP responses in an unreliable way (for example all video content). The decision may also be based on the network characteristics (for example in the case of a high RTT to decrease the latency of the video playback).

Then (310), the application informs the HTTP layer that the message is to be sent unreliably.

The preferred mechanism for doing this is to use a specific HTTP header field. For example, the application may use a header field named “unreliable” whose value specifies that the HTTP message is to be transferred unreliably. By setting this header field when creating the HTTP message, the application indicates to the HTTP layer that the message is to be sent unreliably.

For example, to indicate that the message is sent unreliably, the application can set the following header field:

unreliable: true

In a preferred embodiment, the header field has two possible values:
“true” means the body is sent unreliably;
“false”, the default when the header field is not present, means that the whole message is sent reliably.

For being able to also send the header fields unreliably, the header field could have three values:
“body” means the body is sent unreliably;
“full” means that both the body and the header fields are sent unreliably;
“none” (or “false”), the default when the header field is not present, means that the whole message is sent reliably.

For being able to send only a part of the body unreliably, a “start” parameter can be added to the header field value. This parameter indicates the position of the first byte of the body sent unreliably, starting at position 0.

For example, to send a HTTP message with the first 256 bytes of the body sent reliably, the application can set the following header field:

unreliable: body; start=256

For enabling mixing reliable and unreliable parts in the body, a “range” parameter can be added to the header field value. This parameter indicates one or more range of data inside the body that are sent unreliably. Each range is indicated with the position of the first byte of the range followed by the position of the last byte of the range.

For example, to send a HTTP message with the first 256 bytes and 256 bytes starting at byte 5000 transmitted reliably, the application can set the following header field:

unreliable: body; range=256-4999,5256-10000

As an alternative, the reliable parts could be indicated using a “except” parameter in the header field value.

The previous example would be:

unreliable: body; except=0-255,5000-5255

An alternative mechanism for the application to inform the HTTP layer is to use a specific API call when creating the HTTP message.

In a preferred embodiment, the API between the application and the HTTP layer has a function to allow the application to create a new HTTP message. This function contains a parameter for determining whether the created HTTP message is to be transferred reliably or not.

For example, the JavaScript fetch function could be modified to include such a parameter. A client could then send a video in an unreliable way using the following code:

```
fetch (“video-upload”, {
    method: “POST”,
    body: videoContent,
    unreliable: true
})
```

As with the header field mechanism, this mechanism can be adapted to enable indicating that different parts of the HTTP message are unreliable.

For example, instead of being a Boolean, the unreliable parameter could be an array of ranges for specifying the ranges of the body of the HTTP message that are transferred unreliably.

An alternative embodiment of the API is to define two different functions for creating new HTTP messages: one for creating a message transferred reliably, another for creating a message transferred unreliably.

Once the HTTP Layer has been informed that a HTTP message is to be transmitted unreliably, it informs (320) the TA Stream sublayer.

The preferred mechanism is to use a specific API call between the HTTP Layer and the TA Stream sublayer. Two kind of API calls can be used to indicate that a TA Stream is to transmit a HTTP message unreliably. First, a parameter can be transmitted to the TA Stream sublayer upon the creation of the TA Stream. Second, the parameter can be transmitted to the TA Stream sublayer through a dedicated setting function of the TA Stream. Preferably, both mechanisms are present in the API. When the sender is the HTTP client, it is more convenient to configure the TA Stream while creating it. When the sender is the HTTP server, the TA Stream already exists (it was created upon receiving the client's request) and it is more convenient to use the setting function. It should be noted that in both cases the API described here only targets defining the unreliability for sending a message through the TA Stream. The parameter transmitted to the TA Stream sublayer is similar to the content of the HTTP header field described previously.

An alternative mechanism is for the TA Stream sublayer to inspect the header fields of the HTTP message. The TA Stream sublayer learns whether the message is to be transmitted reliably or not depending on the absence or the presence of the unreliable header field described above.

This alternative mechanism enables to use the same mechanism for informing both the HTTP layer and the TA Stream sublayer. However, there is a violation of the protocol boundary between HTTP and TAL: the TA Stream sublayer is no more independent of the content it transports.

The last step (330) is for the TA Stream sublayer to inform the TA Packet sublayer that the HTTP message is to be transmitted unreliably.

To transmit the HTTP message, the TA Stream sublayer will create one or more TA frames containing the message body. Each frame is transmitted to the TA Packet sublayer to be encapsulated in a TA Packet and sent to the receiver. For transmitting an unreliable part of a message body, the TA Stream sublayer creates a TA frame with data from this unreliable part and marks the frame as unreliable. The TA Packet sublayer will send it and will know that the frame is not to be retransmitted even if lost.

Some existing TA frames are already unreliable (for example an ACK frame is not reliable: if lost, an updated ACK frame will be sent). Therefore the TA Packet sublayer already has mechanisms for handling unreliable frames. However, a new API needs to be provided for the TA Stream to be able to create unreliable frames containing data from the message body. This new API needs to include a parameter indicating if the newly created frame is to be reliable or not.

The preferred alternative when only part or parts of the message body are transmitted unreliably is to keep some unreliability markers alongside the message body. For example, the structure containing the message body could also contain the unreliable ranges in this message body. Another possible implementation is to split the message body into several chunks, each chunk containing a part of the message body and a flag indicating whether this chunk is to be transmitted reliably or not.

Taking back the last example for the unreliable header field, the associated structure representing the message body could be:

```
message-body = [
    {
        unreliable=false,
        length=256,
        content=“...”
    },
    {
        unreliable=true,
        length=4744,
        content=“...”
    },
    {
        unreliable=false,
        length=256,
        content=“...”
    },
    {
        unreliable=true,
        length=4744,
        content=“...”
    },
}
```

For optimizing the number of TA frames generated, a frame may contain both reliable and unreliable data. In this case, the whole frame is marked as reliable. In the same way a TA packet containing both a reliable frame and an unreliable frame is considered as reliable.

To enable transmitting the message header fields unreliably, similar mechanisms can be used.

Sender to Receiver-Signalling

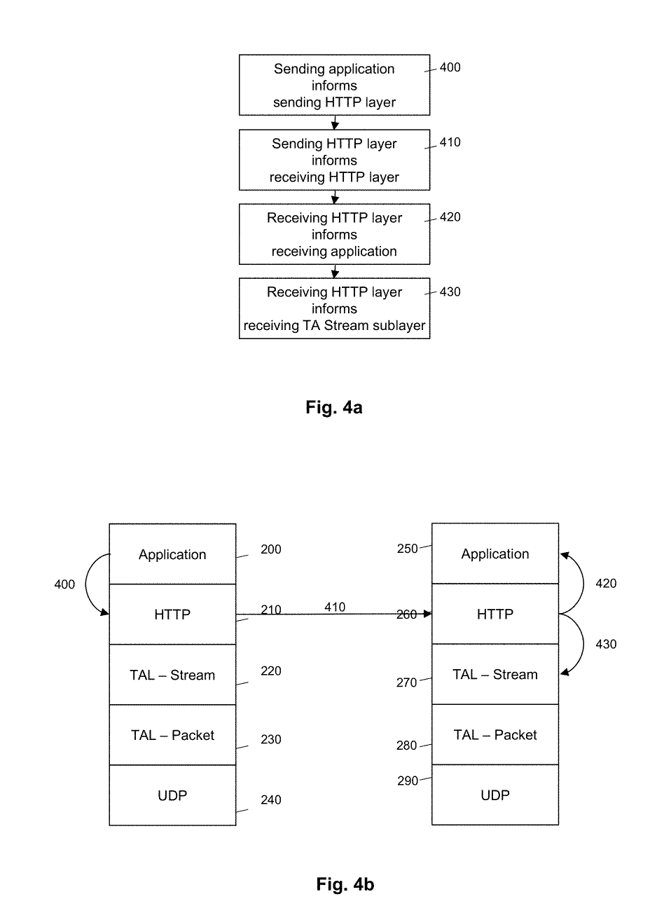

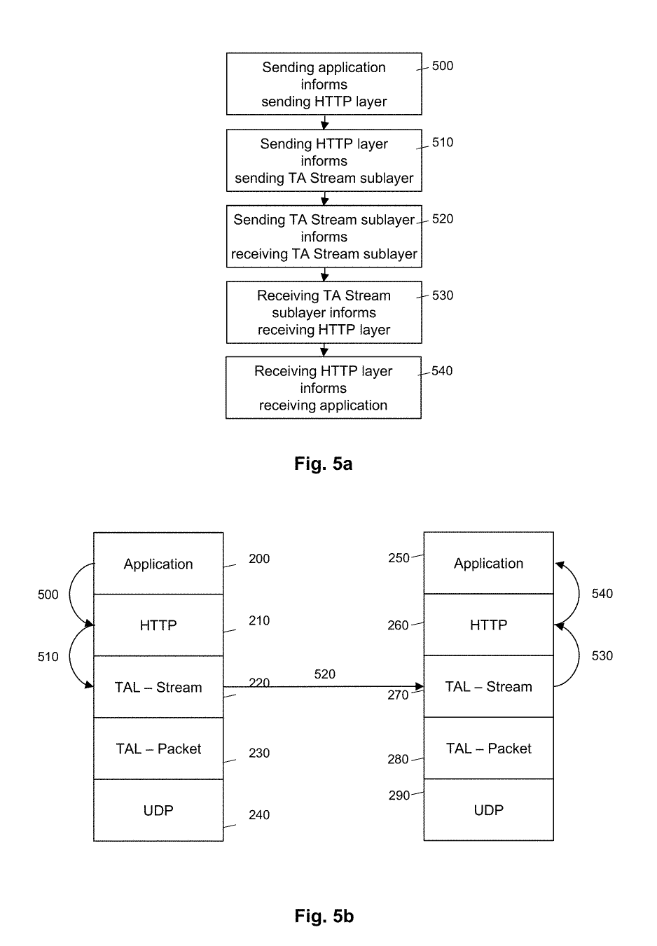

FIGS. 4a, 4b, 5a and 5b describe two possibilities for the signalling between the sender and the receiver.

FIG. 4a illustrates the flowchart and FIG. 4b gives a representation of the inter-layer signalling based on the architecture of FIG. 2.

FIG. 5a illustrates the flowchart and FIG. 5b gives a representation of the inter-layer signalling based on the architecture of FIG. 2.

FIG. 4a describes the preferred embodiment. In this embodiment, the sending application (200) informs (400) the sending HTTP layer (210) that a message is to be transferred unreliably by setting the “unreliable” HTTP header field in the HTTP message. Then the sending HTTP layer (210) informs (410) the receiving HTTP layer (260) that the message is transferred unreliably through this same “unreliable” HTTP header field. The receiving HTTP layer then informs (420) the receiving application (250) and informs (430) the receiving TA Stream sublayer (270) as described hereafter.

As an alternative, the sending application (200) can inform the sending HTTP layer (210) that the message is unreliable using another mechanism such as the specific HTTP API call described previously. In this case, the sending HTTP layer (210) generates the “unreliable” HTTP header field according to the parameters transmitted through the API call.

FIG. 5a describes an alternative embodiment. The sending application (200) informs (500) the sending HTTP layer (210) that the message is to be transferred unreliably through one of the previously described mechanisms. Then the sending HTTP layer informs (510) the sending TA Stream sublayer (220), using also one of the previously described mechanisms. The sending TA Stream sublayer (230) then informs (520) the receiving TA Stream sublayer (270).

This information is transmitted inside metadata associated with the TA Stream sublayer. The metadata is for example specified in a HTTP/2 HEADERS frame. In the HTTP/2 HEADERS frame, the unreliability information could be transmitted as Boolean flag. This only enables to specify whether the message body is reliable or not, as a whole. A second flag could be used to indicate whether the header fields are reliable or not.

Another possibility is to define as specific encoding of the metadata associated with a TA Stream to include this unreliability information. This unreliability information could be encoded as follows:

1-bit reliability indicator
0: reliable stream
1: unreliable stream

For an unreliable stream:
1-bit header fields reliability indicator
   0: reliable header fields
   1: unreliable header fields
1-bit body specific reliability indicator
   0: fully unreliable body
   1: partially unreliable body
For a partially unreliable body
   5-bit number of ranges
   3-bit for encoding size of ranges
      Depending on the value, the range parameters are encoded using 0, 16, 24, 32, 40, 48, 56 or 64 bits
   For each range:
      n-bit range start
      n-bit range length

Many variations of this encoding are possible: some information could be removed for a simpler unreliability mechanism. The size for the number of ranges and the number of possibilities for the range parameters could be changed. The encoding size for a range start and a range length could be independent, etc.

Once the receiving TA Stream sublayer has been informed that the HTTP message it will receive is sent in an unreliable way, it informs (530) the receiving HTTP layer (260), which in turn informs (540) the receiving application (250).

It should be noted that both embodiments could be used simultaneously: the sending HTTP layer (210) would inform the receiving HTTP layer (260) and the sending TA Stream sublayer (220) would inform the receiving TA Stream sublayer (270). In such a case, a mechanism is included on the receiving side to check that the information received by the HTTP layer matches the information received by the TA Stream sublayer.

Receiver Side-Signalling

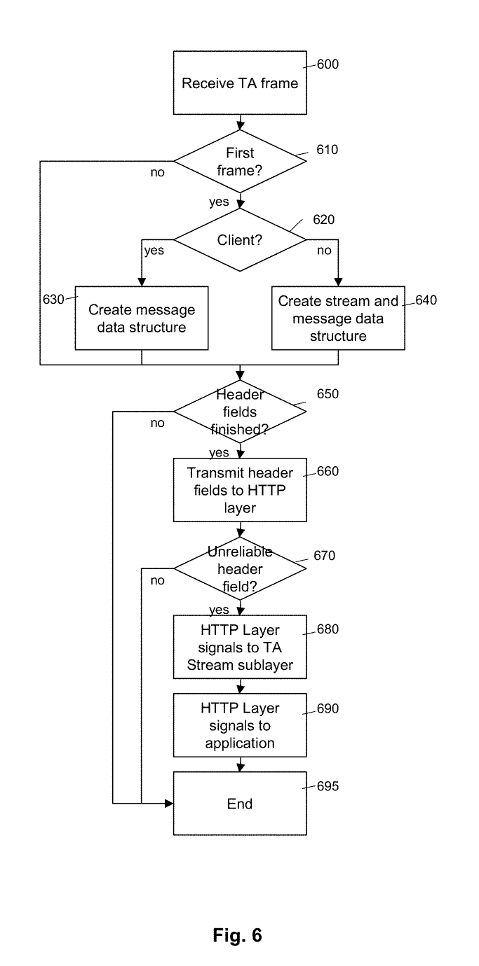

FIG. 6 describes the mechanism used on the receiver side to inform the different layers that a HTTP message is transferred in an unreliable way. This figure describes the preferred mechanism where the signalling is received at the HTTP Layer level, as described by FIGS. 4a and 4b.

In a first step (600), the TA Stream sublayer receives a TA frame containing data for a TA Stream. This TA frame was previously extracted from a TA packet transported by the TA connection. This TA frame can either contain data corresponding to the HTTP header fields of the HTTP message transported through the TA Stream or can contain data corresponding to the body of the HTTP message.

According to one implementation, TA frames containing data corresponding to HTTP header fields are transported on a specific TA Stream different from the TA Stream used for transporting the body of the HTTP message. This specific TA Stream is used to transport the data for all the HTTP header fields of the different HTTP messages exchanged over the TA connection. In the description here, the considered TA Stream is the one used to exchange the HTTP message.

If the TA frame is the first one received for this TA Stream (610), some initial processing is realized. First, the algorithm checks (620) whether the receiver is a client or a server.

In the case of a client (630), the TA Stream already exists, as it was used to send the HTTP request. The algorithm creates any necessary data structure for processing the HTTP message sent by the server as a response to the initial request. If the server used the server push feature, the TA Stream was created upon receiving the push promise from the server.

In the case of a server (640), the data structure used for representing the TA Stream is created and the data structure for processing the HTTP message is also created.

In all cases, it is checked (650) whether the HTTP header fields are fully received. Possibly the HTTP header fields are received as several TA frames. Possibly some TA frames containing data for the body of the HTTP message are received before the HTTP header fields are fully received (or even before any data for the HTTP header fields is received).

If this is not the case, the algorithm ends (695) and will start again at step 600 when a new TA frame is received for the TA Stream. Depending on the implementation, the algorithm could also wait for a new TA frame to be received for the TA Stream and continue directly with step 650.

Otherwise, the algorithm transmits (660) the HTTP header fields to the HTTP layer.

The HTTP layer checks (670) whether the “unreliable” header field is present in the HTTP header fields. If this is not the case, the algorithm ends (695).

If this is the case, then the HTTP layer signals (680) to the TA Stream sublayer that the HTTP message is transmitted in an unreliable way. This is realized preferably through a specific API call as discussed above.

In addition, the HTTP layer informs (690) the application that a new HTTP message is being received and that this HTTP message is transmitted in an unreliable way. This is realized preferably by transmitting to the application the HTTP header fields including the “unreliable” header field, which is transmitted as received from the sender.

As an alternative, this step is realized through a specific API call. In a way similar to above, the function used to transmit the HTTP message to the application contains some parameters for informing the application of the reliability of the HTTP message.

After step 690, the algorithm ends at step 695.

Steps 650 and 660 could be modified to transmit in a streaming way the HTTP header fields received for the HTTP message. In this variant, at step 650, the algorithm checks whether some new data was received for the HTTP header fields. If this is the case, this new data is transmitted during step 660 to the HTTP layer. This enables the HTTP layer to process HTTP header fields as soon as they are received, in a streaming way.

Possibly, in this variant, the TA Stream sublayer may reorder the TA frames carrying data for the HTTP header fields before transmitting the data to the HTTP layer.

Another variant is to replace the step 680 where the HTTP layer signals the unreliability to the TA Stream sublayer by a step (possibly between step 650 and step 660) where the TA Stream sublayer checks the HTTP header fields for the presence of the “unreliable” header field. However, as stated before, this constitutes a violation of the protocol boundary between HTTP and TAL and is not the preferred solution.

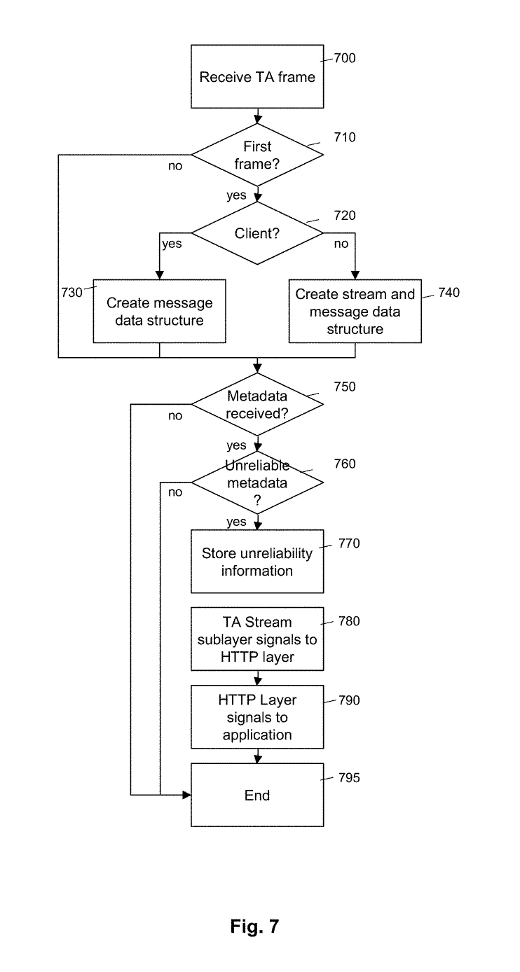

FIG. 7 describes another mechanism used on the receiver side to inform the different layers that a HTTP message is transferred in an unreliable way. This figure describes an alternative mechanism where the signalling is received at the TA Stream sublayer level, as described by FIGS. 5a and 5b.

Steps 700 to 740 are similar to steps 600 to 640 of FIG. 6.

At step 750, the algorithm checks whether the metadata associated to the transmission on the TA Stream has been received. This metadata is described in relation with FIG. 5a.

If this is not the case, the algorithm ends (795) and will start again at step 700 when a new TA frame is received for the TA Stream. Depending on the implementation, the algorithm could also wait for a new TA frame to be received for the TA Stream and continue directly with step 750.

Otherwise, the algorithm checks (760) whether the metadata indicates that the TA Stream is used to transmit unreliably a HTTP message.

If this is the case, the algorithm stores (770) this unreliability information in either the data structure representing the TA Stream or the data structure representing the HTTP message or both.

Then the algorithm transmits (780) this information to the HTTP layer, preferably using a specific API call in a way similar to what was described for the sender side.

Possibly, this step is deferred to when the TA Stream sublayer transmit some information on the received HTTP message to the HTTP layer. Preferably, this step is realized when the TA Stream sublayer transmits the HTTP header fields of the HTTP message to the HTTP layer.

As a last step, the algorithm transmits (790) the unreliability information from the HTTP layer to the application layer. Preferably, this information is transmitted through the “unreliable” header fields, which is added by the HTTP layer based on the information received from the TA Stream sublayer. As an alternative, this information is transmitted through a specific API call in a way similar to what was described for the sender side.

After this, the algorithm ends (795).

Possibly, this step is also deferred to when the HTTP layer transmit some information on the received HTTP message to the application. Preferably, this step is realized when the HTTP layer transmits the HTTP header fields of the HTTP message to the HTTP layer.

As for steps 650 and 660, steps 750 and 760 could be modified to check whether the information about the HTTP message reliability is present as soon as part of the metadata associated with the transmission on the TA Stream has been received, not waiting for the whole metadata to be available.

Note that if the unreliability information is transmitted at both the HTTP layer and the TA Stream sublayer, then the algorithms of FIG. 6 and FIG. 7 are run together. In addition, step 680 is modified for the HTTP layer to check whether the unreliability information receiver from the TA Stream sublayer at step 780 is compatible with the information extracted from the “unreliable” header field at step 670. If these two sources of information are not compatible, then an error is raised. Preferably, the TA Stream is closed as a consequence of this error. As an alternative, one of the source of information is selected and the other is ignored, however this may lead to communication problems between the sender and the receiver.

According to embodiments, unreliability information is communicated at the HTTP Layer (cf. FIG. 4b) as summarized below:
Sender
   Application decides message is unreliable
   Application informs HTTP Layer using an HTTP Header
   HTTP Layer transmits unreliability to receiver using HTTP

Header
HTTP Layer informs TA Stream sublayer using specific API call
   Alternative: HTTP Layer informs TA Stream sublayer using HTTP Header
Receiver
   HTTP Layer retrieves unreliability from HTTP Header
   HTTP Layer informs Application using HTTP Header
   HTTP Layer informs TA Stream sublayer using specific API call
   Alternative: TA Stream sublayer retrieves unreliability from HTTP

Header

According to an alternate embodiment, unreliability information is communicated at the TA Stream sublayer (cf. FIG. 5b) as summarized below:
Sender
   Application decides message is unreliable
   Application informs HTTP Layer using an HTTP Header
      Alternative: Application informs HTTP Layer using specific API call
   HTTP Layer informs TA Stream sublayer using specific API call
   TA Stream sublayer transmits unreliability to receiver using flag in stream metadata
Receiver
   TA Stream sublayer retrieves unreliability information from flag
   TA Stream sublayer informs HTTP Layer using specific API call
   HTTP Layer informs application using HTTP Header
      Alternative: HTTP Layer informs application using specific API call

### Second Embodiments—Packets Transmission

The second problem to solve for enabling the unreliable transmission of TA packets is to be able to inform the receiver, in case a TA packet containing only unreliable TA frames is lost, that the TA packet was sent unreliably and it will not be retransmitted.

Delayed Unreliability Transmission

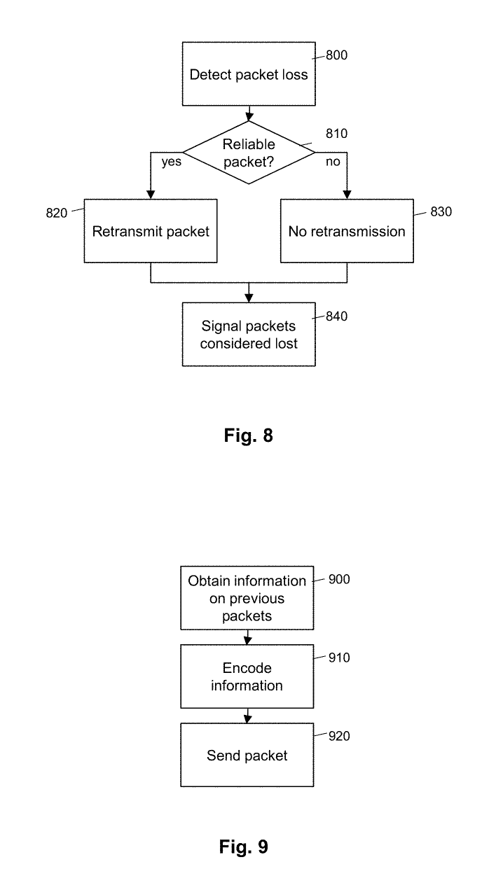

FIG. 8 describes an algorithm used by the sender to inform the receiver that a missing TA packet was sent unreliably.

First (800), the sender detects that the receiver has not received a previously sent TA packet. This detection is realized through the normal TAL processing for loss detection (may be similar to TCP). For example, the sender receives a NACK (Non-Acknowledgement) for the TA packet, or it doesn't receives an acknowledgement in a predetermined timeframe for the TA packet after the sending of the packet.

Then, the sender checks (810) whether the TA packet was reliable or not. As described previously a TA packet is unreliable only if all the TA frames it carries are unreliable. This check is realized by looking at the information stored while generating the TA frame.

If the lost TA packet was reliable, then its retransmission is processed according to a conventional correction algorithm (820). This processing includes sending the content of the lost TA packet inside a new TA packet, and including the lost TA packet into a list of packets that the receiver should not wait for anymore.

If the lost TA packet was unreliable, then it is not retransmitted. However its packet number is included in the list of packet numbers that the receiver should not wait for anymore (830) and that need to be signalled through a STOP_WAITING frame.

In both cases the next step (840) is to signal to the receiver there is no more need to wait for the lost TA packet. This signalling is realized through the use of a STOP_WAITING frame, which indicates to the receiver it should not continue to wait for TA packets with a packet number lower than a value specified in the frame.

Preferably, this step of generating a STOP_WAITING frame is deferred to group the signalling for several TA packets. For example, upon receiving an ACK frame, the algorithm can be used on all the detected lost packets before sending the STOP_WAITING frame. As another example, the generation of the STOP_WAITING frame may be realized only when a TA frame is prepared to be sent inside a TA packet.

As an alternative, in addition of sending a STOP_WAITING frame, a specific frame, UNRELIABLE_PACKETS is send for signalling to the receiver which lost TA packets were unreliable. This new UNRELIABLE_PACKETS frame has a format quite similar to the format of the ACK frame. This UNRELIABLE_PACKETS frame includes the following information:
8-bit Type for identifying the type of the frame.
The packet number of the first unreliable packet lost, encoded on 8, 16, 32 or 48 bits. The encoding size is defined by the frame type using 2 bits.
The number of ranges of unreliable packet lost, encoded on 8 bits.
For each range:
   The packet number of the first packet in the range, encoded as a delta value. This delta value is encoded on 8, 16, 32 or 48 bits. The encoding size is defined by the frame type using 2 bits.
      This delta value is 0 for the first range (the first packet in the first range is the first unreliable packet lost).
      For the subsequent ranges, this delta value is the number of reliable packets between the previous range and the current range (i.e. this is the difference between the number of the first packet in the current range and the number of the last packet in the previous range decreased by 1).
   The number of packets in the range, encoded on 8-bits.

This UNRELIABLE_PACKETS frame can be sent either at the same time, before, or after the STOP_WAITING frame. Preferably, the generation and sending of these two frames are independent.

Timely Unreliability Transmission

FIG. 9 describes the preferred mechanism for informing the receiver that a TA packet is sent unreliably. This algorithm is used when generating a TA packet and its goal is to include in the TA packet information about the reliability of previously sent packets.

The first step (900) is to obtain information on the previously sent packets.

Then, this information is encoded (910) as described hereafter and included in the TA packet to send.

Last, the TA packet is sent (920).

The preferred encoding for step 910 is to use a Boolean flag for the previous packets indicating whether the packet was sent reliably or not. The encoded information could target 8, 16, 32 or more previous packets depending on the expected size of bursts of packet loss. Possibly, the number of packet for which some information is encoded could be indicated with some flags.

For example, the following encoding can be used:
2 bits for specifying the total number of bits used for indicating previous packet reliability (including these 2 bits), the possible values being 8, 16, 24 or 32 bits.
The remainder bits each used for indicating the reliability of a packet, starting with the last packet sent and going back in time.

With this encoding, the following encoded bits would mean:

0111 1001 1101 1110

The reliability information spans 16 bits (the 01 value at the start).

Then, the previous 14 packets reliability was, going backward from the last sent packet: 3 reliable packets, 2 unreliable packets, 3 reliable packets, 1 unreliable packet, 4 reliable packets, 1 unreliable packet.

Another possible encoding use a variable prefix for indicating the number of packets for which reliability information is indicated:
0 starting bit means 8 bits are used in total, of which 7 for reliability values.
01 starting bits means 16 bits are used in total, of which 14 for reliability values.
11 starting bits means 32 bits are used in total, of which 30 for reliability values.

Another possible encoding for step 910 is to use packet ranges for indicating which packets were sent reliably or not. Such an encoding could be:
2 bits for indicating the number of unreliable packet ranges (from 0 to 3).
For each range:
   5 bits for indicating the delta for the last packet in the range.
      For the first range, the delta is counted from the last sent packet.
      For any other range, the delta is the number of reliable packets between the previous range and this range.
   3 bits for indicating the length of the range.

It should be noted that the ranges are indicating starting from the last packet sent and going backward in time.

With this encoding, the previous example could be encoded as follows:

11 00011 010 00011 001 00100 001

This encoding is more efficient than the previous one if sent packets are grouped according to their reliability.

Another possible encoding includes more information about each packet: it not only includes its reliability but also the number of the TA Stream whose data the TA packet carries. This information can be useful when solving the Received Data Processing problem (see description below). Such an encoding could be:
1 bit indicating the stream number encoding size (8 or 16 bits).
7 bits indicating the number of packets for which some information is included (this should be limited to prevent using too much space in the packet encoding, a reasonable limit could be a maximum of 32 packets).
For each packet, starting from the last packet sent and going backward in time:
   A signed integer (on 8 or 16 bits) indicating the stream number as a delta from the previous stream number. The initial stream number being the stream number corresponding to the packet being generated.

Using this encoding, the reliability property of each packet is retrieved by look at the reliability of the corresponding TA Stream.

An option to this encoding is to use the first bit of the packet number delta to indicate the reliability of the packet.

The drawback of this encoding is that it doesn't support grouping TA frames for several TA Streams inside a single TA Packet. An alternative for solving this problem could be:
1 bit indicating the stream number encoding size (8 or 16 bits).
7 bits indicating the number of frames for which some information is included (again this should be limited to prevent using too much space in the packet encoding).
For each frame, starting from the last frame sent and going backward in time:
   1 bit indicating whether the frame belongs to a different packet or not.
   7 or 15 bits for encoding the stream number delta for the frame.
      The reference for the first delta is the stream number of the first frame corresponding to a TA Stream included in the packet being generated.
      For any other delta, the reference is the stream number of the previous frame.

In this encoding, frames that are not associated to the content of a stream are not taken into account.

A variant for all these encodings is to include some information on future TA packets. However, this means that the reliability information of these future TA packets is known. This is only possible if the content of these TA Packets is buffered before effectively generating the next TA Packet to send. Using such a variant should be reserved when the TA Packet layer has enough information for generating several packets at once. This could happen, for example, when a TA Stream has a large amount of data to send that will span several packets.

This variant is useful for transmitting the reliability information for the last TA Packet to be sent in a group of packets. For example, the packet containing the last part of a HTTP message may not be followed immediately by any other packet. In this case, the reliability information for this packet cannot be transmitted TAkly to the receiver by including it in some following packet. However, it could have already been transmitted to the receiver in some previous packet.

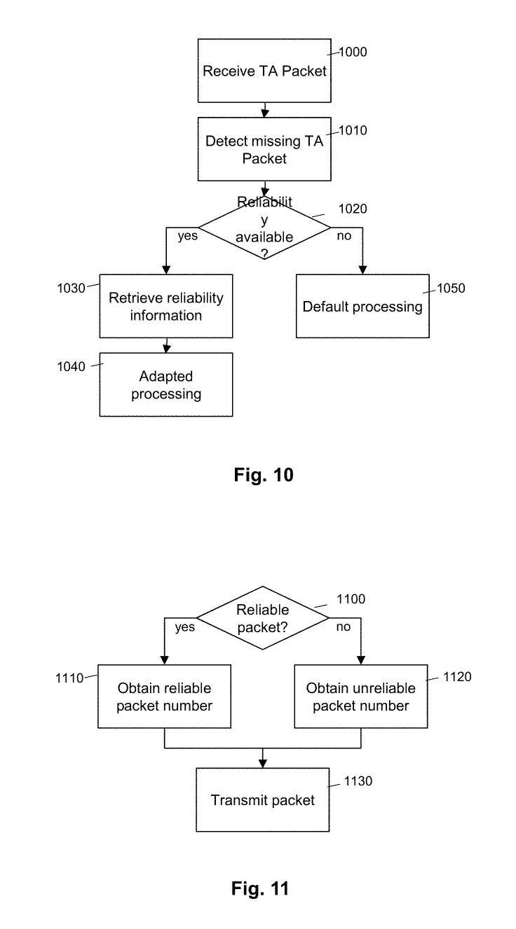

FIG. 10 describes the processing on the receiver side.

Upon receiving a TA Packet (1000), the receiver saves the reliability information contained in this packet.

Upon detecting that a TA Packet is missing (1010), the receiver checks whether any reliability information about this packet is available (1020). This check is realized by looking into the saved reliability information.

If the reliability information for the missing TA Packet is available, it is retrieved (1030) and the missing packet is processed accordingly (1040).

Otherwise, the TA Packet follows the default processing as if it was a reliable packet (1050).

Combination with Delayed Unreliability Transmission

The timely unreliability transmission described above can be combined with the delayed unreliability transmission. The delayed unreliability transmission is used when the timely unreliability transmission doesn't convey the unreliability information for a missing packet.

This can happen if too many packets are lost and the encoding used doesn't allow to specify the unreliability information for all the missing packets. For example, the first encoding, only enables to specify the reliability information for up to 30 packets.

This can also happen for the last packet of a group of packets, as described previously (or even for the few last packets of a group of packets).

In all these cases, the receiver can fall back to processing these packets as if they were reliable, asking their retransmission and learning they were unreliable once the sender signals it through the delayed unreliability transmission mechanism.

Split Connection

Another mechanism for indicating to the receiver whether a TA packet is reliable or not it to use two different numbering for TA packets, one for the reliable packets, and another for the unreliable packets.

This updated numbering scheme is as follows:
1 bit for indicating whether the packet is reliable or not (the value 1 being for reliable packets)
The remaining bits (7, 15, 31 or 47) are used for the packet number. As in the TA specification, each new packet has a number one larger than the previous packet. However, here, reliable and unreliable packets are numbered independently.

FIG. 11 describes the processing according to this new mechanism on the sender side.

First, the sender checks (1100) whether the TA packet to send is reliable or not.

If it is reliable (1110), then the algorithm obtains the next packet number for a reliable packet and encode it into the packet structure.

If it is not reliable (1120), then the algorithm obtains the next packet number for an unreliable packet and encode it into the packet structure.

In both case, the processing continues (1130) by sending the TA packet to the receiver.

Note that on the sender side, the processing should be adapted for handling both channels of packets. Some frames need to be adapted for supporting both types of packets.

For example, the sender should send STOP_WAITING frames for both reliable and unreliable packets. A STOP_WAITING frame inside a reliable packet carries information about reliable packets while a STOP_WAITING frame inside an unreliable packet carries information about unreliable packets. As an alternative, the STOP_WAITING frame could be modified to include signalling for both the reliable and unreliable packets.

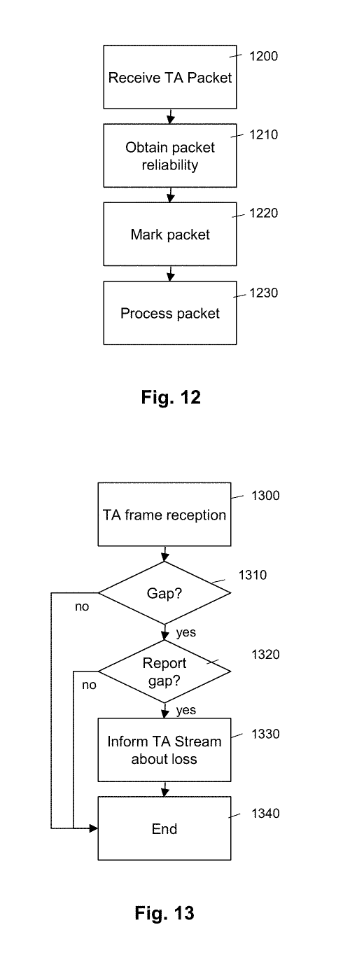

FIG. 12 describes the processing on the receiver side.

First, the receiver receives (1200) a TA packet from the sender.

It then checks (1210), using the first bit of the packet number, whether the packet is a reliable or unreliable packet.

Depending on the result of this check, the packet is marked (1220) as either reliable or unreliable, using the data structure used for processing the packet.

Then the processing of the packet continues as normal (1230). Reliable packets are processed according to the rule of the TA specification. Unreliable packets follow the same processing, except for acknowledging packet reception. For unreliable packets, no acknowledgement is sent back to the sender.

When using two different channels in this way, the frames containing data will be sent only on the channel corresponding to the reliability of the data they contain. For other frames, if possible they are sent inside the first packet available. For example, an ACK frame could be sent in either a reliable or unreliable packet. Frames that need to be carried reliably, or that target specifically reliable frames or packets are sent inside reliable packets.

In addition, the structure of the unreliable packet can be modified to carry information on the TA Stream corresponding to the previous unreliable packets, as described previously.

Here is an overview of a delayed unreliability transmission according to an embodiment of the invention:

Sender
Detects a packet was not received
   Receives a NACK
   Doesn't receive an ACK in a given timeframe
Checks whether packet was reliable or not
If packet unreliable, informs receiver by means of:
   STOP_WAITING frame
   Specific frame (similar to ACK frame, but with list of unreliable packets)

There is thus provided a method of transmitting data packets from a first device to a second device, the method comprising at the first device:

sending a data packet to the second device;

if a request for retransmitting the data packet is received from the second device, the method further comprising:

obtaining reliability information on whether the sent data packet is of reliable type or unreliable type; and

if the data packet is of reliable type, then the data packet is resent to the second device; and

if the data packet is of unreliable type, then a notification is sent to the second device for notifying the second device that the data packet is not to be resent.

According to an alternate embodiment;

Sender
In each packet, adds information about reliability of other packets
   Preferably for previous packets
      Bit-map information: 1 bit for each previous packet, acting as a flag (1=reliable). 1 to 4 bytes of information. Preferably for previous packets, possibly for a few following packets.
      Sparse array information: 1+ windows of unreliable packets: offset of previous unreliable packet+number of unreliable packets.

### Improvement:

Sender
In each packet, adds information about the stream of other packets
   Reliability information can be retrieved from the stream
      Array information: stream ids are encoded as a delta from id of stream in the current packet.
      Unreliable-only information: for each packet, 1 bit for indicating if packet is unreliable, and if true, adding the stream id (encoded as a delta from stream in the current packet).

According to one aspect, there is provided a method of transmitting data packets from a first device to a second device, the method comprising at the first device:

for each data packet to be transmitted, obtaining reliability information on whether the data packet is of reliable type or unreliable type;

constructing an association table associating identifiers of a plurality of data packets and corresponding reliability information; and

sending a data packet to the second device, wherein the sent data packet include the association table constructed for data packets previously transmitted.

According to another aspect, there is provided method of receiving by a second device data packets from a first device, the method comprising at the second device:

receiving a data packet from the first device;

retrieving from the received data packet an association table associating identifiers of a plurality of data packets, previously transmitted by the first device, and corresponding reliability information;

determining, based on the association table, a data packet previously transmitted by first device, not correctly received by second device, a which is of reliable type; and

requesting retransmition of the data packet.

### Third Embodiments—Received Data Processing

The third problem to solve is on the receiver side to transmit in a timely manner the received data, even when part of it is lost. In particular, the TA layers should detect that some data belonging to a HTTP message transmitted unreliably has been lost and inform in a timely manner the HTTP layer and indirectly the application layer.

This problem can be split into three sub-problems, the first one being the detection of a TA packet loss in relation with a TA stream. The second problem is the evaluation of the size of the data contained in the lost packet. The third problem is deciding upon the replacement content to transmit to the HTTP layer.

Solution Overview:

Determining Some Data is Lost

Receiver
Upon receiving one (or more) data frame after one (or more) non received frame
   Decide the one (or more) non received frame are lost
After receiving a frame for a stream
   Compute an expected delay between two frames for the stream
      This expected delay is an average delay taking into account possible jitter in data transmission
   If this expected delay modified by an allowance factor elapses without receiving the next frame
      Decide that the next frame is lost

Lost Data Size

Receiver
If some further data has been received:
   Use the position of this further data to determining the lost data size
Otherwise:
   Compute an average rate for data reception on the stream
   Compute the expected size since reception of last data
   Optionally decrease the size to take into account jitter in
   Use this size as the lost data size

Lost Data Content

Receiver
Replace lost data content with 0 padding
Optionally indicate to application that the data was lost

Determining Some Data is Lost

There are several ways for a receiver to detect that some data in a TA stream has been lost. These mechanisms can be used separately, but preferably they can be used together to improve the detection of packet loss.

Gap Detection Mechanism

FIG. 13 describes a first mechanism based on gap detection during the reconstruction of the TA stream. Upon receiving a TA frame (1300) for a TA stream, the algorithm insert it at the corresponding position in the TA stream.

Then, the algorithm checks (1310) whether there is any gap in the TA stream prior to this frame.

If this is not the case, the algorithm ends (1340) and the normal processing of the TA packet continues.

If this is the case, the algorithm preferably checks (1320) whether this gap should be reported to the HTTP layer.

A first check is to count the number of frames containing data positioned after this gap that have been received. If this number is greater than or equal to a predefined number, for example 3, then the check indicates that the gap should be reported.

A second check is to measure the time elapsed since the reception of the first frame containing data positioned after this gap. If this elapsed time is greater than or equal to a predefined threshold, for example ¼ RTT, then the check indicates that the gap should be reported.

This second check is preferably realized by a timer created upon the reception of the first frame containing data positioned after this gap.

Preferably, step 1320 verify if any one of the checks indicate that the gap should be reported.

If the gap should not be reported, the algorithm ends (1340) and the normal processing of the TA packet continues.

Otherwise, the algorithm informs (1330) the TA Stream that some data has been lost, as described hereafter.

Then the algorithm ends (1340).

Timeout-Based Mechanism

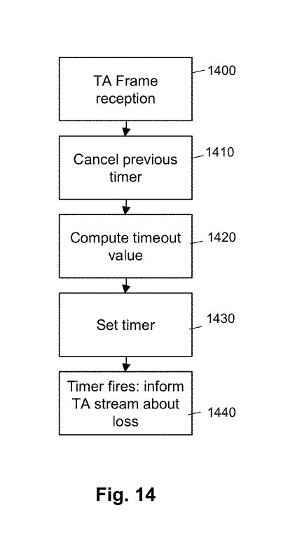

FIG. 14 describes a second mechanism based on a timeout system. Upon receiving a TA frame (1400) for a TA stream, the algorithm cancels (1410) any timer previously set for the TA stream by this algorithm.

Then, the algorithm computes a timeout value (1420). This timeout value correspond to the expected arrival of the next TA frame containing data for this TA stream. It is based on the average reception rate of TA frames, on some allowance for taking into account that some TA frames may carry data for other TA streams, and on some allowance for the irregularity in the rate transmission of the network.

The average reception rate of TA frames can either be obtained by a direct measure of this value. Preferably, it is computed from a measure of the average bandwidth:

$$global\_reception \_rate = \frac{bandwidth}{packet\_size}$$

The packet_size is set to the average rate of TA packet size.

The average reception rate of TA frames for the TA stream depends on two factors. The first factor is the ratio of the bandwidth dedicated to the TA stream. It can either be estimated from the priorities of the different TA stream receiving data from the sender, or measured from the TA frame received. Preferably, this ratio is estimated from the priorities when the TA stream starts receiving data and then measured once enough data has been received for the measure to be relevant.

The second factor is the size of the frame grouping for the TA stream: the sender may send several frames successively for the TA stream, increasing the delay before a new frame is transmitted for this stream. As the size of a burst of frames for a given TA stream can vary, the value retained should take into account the different size. Using an average size may result in evaluating a too short timeout for a burst bigger than the average. Therefore, the preferred estimated value is the value of the 75 percentile for the different burst size for the stream (meaning that the estimated value is such that 75 percent of the measured burst size are lower than or equal to this estimated value). An alternative is to use a higher percentile or the maximum burst size.

The average reception rate of TA frames for the TA stream is then:

$$stream\_reception \_rate = \frac{global\_reception \_rate \times stream\_bandwidth \_ratio}{stream\_burst \_size}$$

Last, this stream_reception_rate is converted to an expected delay, which is corrected by an allowance factor for the irregularity in the rate transmission of the network. The preferred correction is based on the RTT between the sender and the receiver, for example, adding ¼ RTT to the expected delay.

The timeout is then:

$$timeout\_value = \frac{1}{stream\_reception \_rate} + \frac{1}{4} RTT$$

As an alternative, the correction is based on the measured variation of the transmission rate of the network.

The next step of the algorithm (1430) is to set a timer based on this timeout value.

If the timer fires, after the timeout time elapses without the timer being cancelled, then the algorithm informs (1440) the TA Stream that some data has been lost, as described hereafter.

Note that an implementation could be optimized by combining the cancelling of the timer previously set (1410) and the setting of a new timer (1430) in a single step of resetting the timer.

Note also that if all the data for the stream has been received, no timer is set.

Lost Packet Mechanism

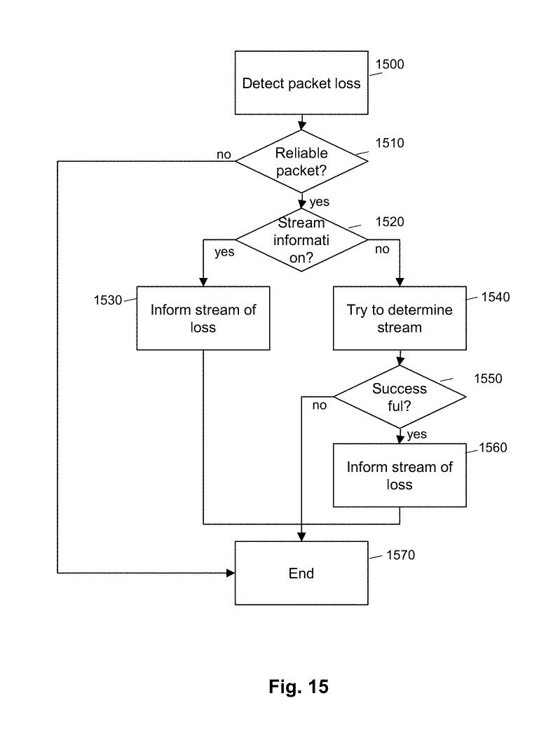

FIG. 15 described a third mechanism based on the detection of a packet loss.

When the receiver detects that a packet is loss (1500), using a conventional algorithm, it checks whether it knows if the packet was unreliable (1510). During this check, the algorithm may find that it knows the packet is reliable or that it doesn't have any information about the packet reliability. The reliability information can be obtained through one of the mechanisms described above.

If the packet is reliable or if its reliability is unknown, then the algorithm ends (1570).

If the packet is unreliable, then algorithm checks (1520) whether it has some information about the TA stream corresponding to frames carried in the packet.

If this is the case, then the algorithm obtains this information and indicates (1530) to the corresponding TA stream or TA streams that a packet containing data for this stream or these streams has been lost, as described hereafter.

Then, the algorithm ends (1570).

When there is no information available about the TA stream corresponding to the data in the lost packet, the algorithm tries to determine (1540) to which stream the data corresponds.

For this determination, the algorithm checks for which stream there is a gap in the received data. It also checks that only one packet is missing in the list of packets being received. If both conditions are met, this means the lost packet is the one corresponding to the gap.

Additionally, if only one stream is receiving data from the sender, then the algorithm could estimate that the data in the lost packet correspond to this stream. This could be wrong if the data correspond to a new stream.

The algorithm then checks whether the determination was successful or not (1550).

If the determination is successful, the algorithm indicates (1560) to the corresponding TA stream that a packet containing data for this stream has been lost, as described hereafter.

In both cases, the algorithm ends (1570).

Lost Data Size

When some data is determined as being lost, the size of the lost data has to be determined to inform the TA stream and then the HTTP layer.

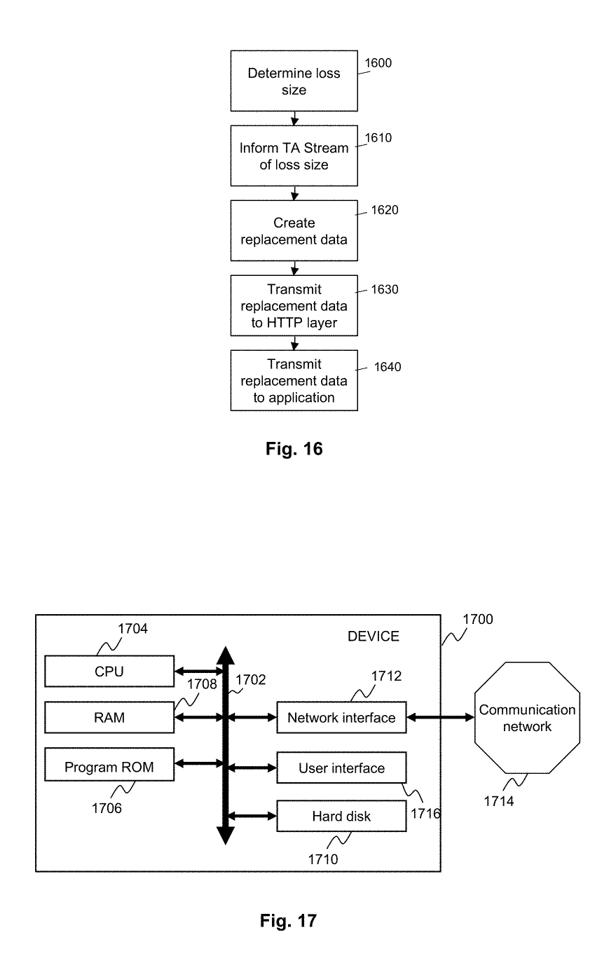

FIG. 16 describes how the lost data size is evaluated.

In a first step (1600), the algorithm determines the size of the lost data, depending on the mechanism used for determining there has been a loss.
For step 1330, the lost data size is the gap size.
For step 1440, the lost data size is estimated from the size of a packet. The size of a packet is preferably determined based on the observed size of the previously received packets. As an alternative, in particular when only a few packets have been received from the sender, the size of a packet is determined based on the expected MTU (Maximum Transmission Unit, the maximum size of a packet that can be transmitted as a whole), for example 1350 bytes for IPv6 or 1370 bytes for IPv4.
The size of the data contained in the lost packet is determined from the size of the lost packet by subtracting the size of the TA packet header and the TA frame header.
In addition, this size should be further reduced to take into account the presence of a control frame, such as an ACK frame, in the packet. The size of the control frame is preferably determined based on the observed size of the control frames in the previously received packets. The size kept is either the maximum size observed, or the size corresponding to a high percentile of the size observed, such as the 75 or 90 percentile. As an alternative, the control frame size can be estimated from the structure of the control frames. As a summary, the lost data size is computed as follows:
   lost_size=packet_size−packet_header_size−frame_header_size−control_frame_size
To take into account the possibility of a burst of packets for the stream, this lost data size can be multiplied by the estimated size of the burst, taking here a low value for the burst size, such as the 25 percentile, the median, or the minimum value.
As further packets in the burst may not be lost but could arrive at a later time, especially if the burst contains many packets, this lost data size is preferably delayed in time.
For step 1530, if only one stream corresponds to the data in the lost packet, then the lost data size correspond to the packet size. This size is estimated as described above.
For step 1530, if several streams correspond to the data in the lost packet, then the lost data size should be spread over the different streams. However, as the split between the different streams is not known, the lost data size should have a low estimation.
Preferably in this case, the loss is not transmitted to the TA streams.
As an alternative, the lost data size is estimated as described above. Then this size is divided by the number of streams and further reduced by a factor of 2 or 3.
As another alternative, the lost data size for each stream is estimated to a small number of bytes, for example 10 bytes.
As another alternative, when only two streams correspond to the data in the lost packet, then the algorithm checks whether the data not yet received for one the streams is much smaller than the lost data size, for example being at most half the size of the lost data. In this case, the algorithm estimates the lost data size for this stream nearing completion to the size of the data not yet received. It also estimates the lost data size for the other stream to be the remaining of the lost data size.
For step 1560, the determination is the same as for step 1530 in the case where only one stream corresponds to the data in the lost packet.

Then, the each TA stream is informed (1610) about the size of the lost data.

Lost Data Content

The algorithm continues by creating (1620) some replacement data for the lost data. This replacement data is realized by filling the lost data with 0 padding, using the estimated size of the lost data.

Then, the algorithm transmits (1630) this replacement data to the HTTP layer.

Possibly, the algorithm informs the HTTP layer that the data was lost and has been replaced. This is preferably realized through a specific API call.

For example transmitting the replacement data along with a flag indicating that this data was lost. In this case is both received data and replacement data are transmitted to the HTTP layer, several API call are necessary.

Another option is to transmit the data to the HTTP layer with an array containing the ranges corresponding to the replacement data. A variant being to transmit the data to the HTTP layer as an array of chunks, each chunk carrying in addition to a part of the data a flag indicating whether this correspond to lost data or not.

Last, the HTTP layer transmits (1640) the replacement data to the application. This step can be realized asynchronously of the previous steps.

Here again, the HTTP layer can inform the application that the data was lost and has been replaced. A described for step 1630, this is preferably realized through a specific API call.

FIG. 17 represents a block diagram of a computer device 1700, for instance a client or server device, in which steps of one or more embodiments may be implemented.

The device 1700 may be an end-user device such as a mobile device, a micro-computer (laptop), a workstation, a desktop computer or a light portable device. It may also be a proxy device.

The device 1700 comprises a communication bus 1702 to which there are preferably connected:
a central processing unit 1704, such as a microprocessor, denoted CPU;
a read only memory 1706, denoted ROM, for storing computer programs for implementing the invention;
a random access memory 1708, denoted RAM, for storing the executable code of methods according to embodiments of the invention as well as the registers adapted to record variables and parameters necessary for implementing methods according to embodiments of the invention;
a communication interface 1712 connected to the communication network 1714 over which a client-server based communication may be implemented. The communication interface is provided to send requests or responses, such as HTTP requests/responses including web data, possibly in the Push or Pull model of communication, as well as to receive the requests or responses; and
a data storage means 1710 such as a hard disk, for storing computer programs for implementing steps of one or more embodiments of the invention and for storing data, during the implementation of one or more embodiments of the invention, and typically for implementing a cache memory. The cache memory—also called cache—is made of a plurality of cache entries, configured to store data.

Optionally, the device 1700 may also include interfaces 1716 to display information to, and/or receive inputs from, a user. For instance, it may be a screen for displaying data such as a web page in the case of the device and/or serving as a graphical interface with a user, by means of a keyboard or any other pointing means.

The communication bus provides communication and interoperability between the various elements included in the device 1700 or connected to it. The representation of the bus is not limiting and in particular the CPU 1704 is operable to communicate instructions to any element of the device 1700 directly or by means of another element of the device 1700.

The disk 1710 may be replaced by any information medium such as for example a compact disk (CD-ROM), rewritable or not, a ZIP disk or a memory card and, in general terms, by an information storage means that can be read by a microcomputer or by a microprocessor, integrated or not into the device, possibly removable, and adapted to store one or more programs whose execution enables a method according to the invention to be implemented.

Instructions relating to the software application may be loaded to the main memory 1708 from a hard-disk (HD) 1710 or the program ROM 1706 for example. According to a variant, the executable code of the programs may be received by means of the communication network 1714, via the interface 1712, in order to be stored in one of the storage means of the device 1700, such as the hard-disk 1710, before being executed. Such software application, when executed by the CPU 1704, causes the steps described with reference to FIGS. 3a to 16 to be performed in the device 1700.

The CPU 1704 is adapted to control and direct the execution of the instructions or portions of software code of the program or programs according to the invention, which instructions are stored in one of the aforementioned storage means. On powering up, the program or programs that are stored in a non-volatile memory, for example on the hard-disk 1710 or in the ROM 1706, are transferred into the RAM 1708, which then contains the executable code of the program or programs, as well as registers for storing the variables and parameters necessary for implementing the invention.

In this embodiment, the device is a programmable apparatus which uses software to implement the invention. However, alternatively, the present invention may be implemented in hardware (for example, in the form of an Application Specific Integrated Circuit or ASIC). It may consist of one or more dedicated integrated circuits that are capable of implementing the method as described with reference to FIGS. 3a to 16.

While the invention has been illustrated and described in detail in the drawings and foregoing description, such illustration and description are to be considered illustrative or exemplary and not restrictive, the invention being not restricted to the disclosed embodiment. Other variations to the disclosed embodiment can be understood and effected by those skilled in the art in putting into practice (i.e. performing) the claimed invention, from a study of the drawings, the disclosure and the appended claims. It is to be noted that resources or main resources may be sub-resources of other resources and that sub-resources or auxiliary resources may be requested as main resources.

In the claims, the word “comprising” does not exclude other elements or steps, and the indefinite article “a” or “an” does not exclude a plurality. A single processor or other unit may fulfil the functions of several items recited in the claims. The mere fact that different features are recited in mutually different dependent claims does not indicate that a combination of these features cannot be advantageously used. Any reference signs in the claims should not be construed as limiting the scope of the invention.

1. A method of transmitting data packets from a first device to a second device, the method comprising at the first device:
sending a data packet to the second device;
upon reception of a request for retransmitting the sent data packet from the second device, obtaining reliability information on whether the sent data packet is of reliable type or unreliable type; and
if the data packet is of reliable type, then the data packet is resent to the second device; and
if the data packet is of unreliable type, then a notification is sent to the second device for notifying the second device that the data packet is not to be resent.

2. The method of claim 1 further comprising the steps of:
for each data packet to be transmitted, obtaining reliability information on whether the data packet is of reliable type or unreliable type; and
constructing an association table associating identifiers of a plurality of data packets and corresponding reliability information;
wherein the sent data packet include the association table constructed for data packets previously transmitted.

3. A method of receiving by a second device data packets from a first device, the method comprising at the second device:
receiving a data packet from the first device;
retrieving from the received data packet an association table associating identifiers of a plurality of data packets, previously transmitted by the first device, and corresponding reliability information;
determining, based on the association table, a data packet previously transmitted by first device, not correctly received by second device, a which is of reliable type; and
requesting retransmition of the data packet.

4. The method of claim 2 wherein the association table is a bit-map table.

5. A computer program product for a programmable apparatus, the computer program product comprising instructions for carrying out each step of the method according to claim 1 when the program is loaded and executed by a programmable apparatus.

6. A computer-readable storage medium storing instructions of a computer program for implementing the method according to claim 1.

7. A first device for transmitting data packets to a second device, the first device being configured for:
sending a data packet to the second device;
upon reception of a request for retransmitting the sent data packet is received from the second device, obtaining reliability information on whether the sent data packet is of reliable type or unreliable type; and
if the data packet is of reliable type, then the data packet is resent to the second device; and
if the data packet is of unreliable type, then a notification is sent to the second device for notifying the second device that the data packet is not to be resent.

8. The first device of claim 7 further configured for:
for each data packet to be transmitted, obtaining reliability information on whether the data packet is of reliable type or unreliable type; and
constructing an association table associating identifiers of a plurality of data packets and corresponding reliability information;
wherein the sent data packet include the association table constructed for data packets previously transmitted.

9. A second device for receiving data packets from a first device, the second device being configured for:
receiving a data packet from the first device;
retrieving from the received data packet an association table associating identifiers of a plurality of data packets, previously transmitted by the first device, and corresponding reliability information;
determining, based on the association table, a data packet previously transmitted by first device, not correctly received by second device, a which is of reliable type; and
requesting retransmition of the data packet.

10. The method of claim 3 wherein the association table is a bit-map table.

11. A computer program product for a programmable apparatus, the computer program product comprising instructions for carrying out each step of the method according to claim 3 when the program is loaded and executed by a programmable apparatus.

12. A computer-readable storage medium storing instructions of a computer program for implementing the method according to claim 3.

13. The device of claim 8 wherein the association table is a bit-map table.

14. The device of claim 9 wherein the association table is a bit-map table.
